(19) United States
(12) Patent Application Publication
(10) Pub. No.: US 2017/0251481 A1
(43) Pub. Date: Aug. 31, 2017

(54) COMMUNICATION CONTROLLER, WIRELESS COMMUNICATION SYSTEM, AND CHANNEL ASSIGNMENT METHOD

(71) Applicant: FUJITSU LIMITED, Kawasaki-shi (JP)

(72) Inventors: Takayoshi NAKAYAMA, Kawasaki (JP); Hiroshi Fujita, Yokosuka (JP); Dai Kimura, Yokohama (JP)

(21) Appl. No.: 15/406,333

(22) Filed: Jan. 13, 2017

(30) Foreign Application Priority Data
Feb. 25, 2016 (JP) 2016-034042

(51) Int. Cl. H04W 72/08; H04L 12/24; H04L 12/26

(52) U.S. Cl. CPC H04W 72/082; H04L 43/0894; H04L 41/142

(57) ABSTRACT

A communication controller includes a memory, and processor circuitly coupled to the memory and configured to calculate an expected value of an interference amount in a first wireless communication apparatus and a second wireless communication apparatus on the basis of a first use probability in a first frequency bandwidth, a second use probability in a second frequency bandwidth, the first and second frequency bandwidth being calculated on the basis of the traffic of a terminal apparatus, and received power of a signal received by the first wireless communication apparatus from the second wireless communication apparatus, assign a first or second channel to the first and second wireless communication apparatuses on the basis of the expected value, and notify the first or second channel which has been assigned to the first and second wireless communication apparatuses.

### CROSS-REFERENCE TO RELATED APPLICATION

This application is based upon and claims the benefit of priority of the prior Japanese Patent Application No. 2016-034042, filed on Feb. 25, 2016, the entire contents of which are incorporated herein by reference.

### FIELD

The embodiments discussed herein are related to a communication controller, a wireless communication system, and a channel assignment method.

### BACKGROUND

Currently, terminal apparatuses (or users) may utilize not only a wireless access scheme such as Long Term Evolution (LTE) but also a wireless access scheme such as a wireless local area network (wireless LAN). In the case where both the wireless access schemes are available, the terminal apparatuses may utilize the LTE in priority to the wireless LAN, for example. This makes it possible to reduce a load on the LTE system, for example.

The wireless LAN is a wireless access scheme, the specifications of which were considered by the Institute of Electrical and Electronic Engineers (IEEE), for example. Examples of the wireless LAN include IEEE 802.11ac (or Very High Throughput (VHT)) and IEEE 802.11n. Meanwhile, the LTE is a wireless access scheme, the specifications of which were considered by the Third Generation Partnership Project (3GPP), for example.

The IEEE 802.11ac occasionally uses dynamic bandwidth control. The dynamic bandwidth control is a control scheme in which a transmission bandwidth is selected from a plurality of candidates for the transmission bandwidth, for example. In the dynamic bandwidth control, a frequency bandwidth (hereinafter occasionally referred to as a “bandwidth”) of 20 MHz may be used as a unit, and wireless communication may be performed in a bandwidth such as 20 MHz, 40 MHz, 80 MHz, and 160 MHz using a combination of such units. In this event, a bandwidth of 20 MHz, which is called a “primary channel”, is set, and a channel utilization pattern that includes the primary channel is utilized.

FIG. 23 illustrates an example of the channel utilization pattern. In FIG. 23, an IEEE channel number is given to each bandwidth of 20 MHz for differentiation from other bandwidths of 20 MHz. For example, in the case where a channel with an IEEE channel number of “36” is set as the primary channel, an access point performs wireless communication using the channel “36” in the case where wireless communication is performed in 20 MHz. In the case where wireless communication is performed in a bandwidth of 40 MHz, meanwhile, an access point performs wireless communication utilizing “36” and “40”. In the case where wireless communication is performed in 80 MHz, an access point uses channels additionally including “44” and “48”. Even in the case where an access point sets a channel with an IEEE channel number of “40” as the primary channel, the access point selects “36” and “40” in the case where wireless communication is performed in 40 MHz, and additionally selects “44” and “48” in the case where wireless communication is performed in 80 MHz. In this way, in the case where wireless communication is performed in a broad band of 40 MHz or more, consecutive channels that include the primary channel are selected.

In this case, an access point selects channels utilizing a Request to Send/Clear to Send (RTS/CTS) protocol, for example. That is, an access point transmits an RTS signal corresponding to each 20 MHz, and receives a CTS signal as a response signal. The access point may utilize a channel, a CTS signal for which has been received.

For example, a case where an access point sets “36” as the primary channel is considered. In this case, the access point transmits RTS signals corresponding to bands of “36” to “64”. If CTS signals corresponding to “36” and “40” are received, the access point may utilize 40 MHz using “36” as the primary channel and using “40” as a secondary channel. If CTS signals corresponding to “44” and “48” are further received, in addition, the access point may utilize 80 MHz from “36” to “48”.

In the case where a CTS signal corresponding to “36” may not be received, however, the access point may not perform wireless communication in 20 MHz. In the case where a CTS signal corresponding to “36” is received but a CTS signal corresponding to “40” is not received, meanwhile, the access point may not perform wireless communication in 40 MHz, but may perform wireless communication utilizing 20 MHz as the primary channel.

Such dynamic bandwidth control enables terminal apparatuses to perform wireless communication in a broad band, for example.

Examples of techniques related to wireless communication will be described below. There is a technique related to dynamic channel assignment, in which a bias corresponding to a Received Signal Strength Indicator (RSSI) is applied to the arrangement of wireless channels, which includes a primary channel, in each Basic Service Set (BSS) based on a piecewise linear function to adjust the arrangement.

There is a dynamic frequency selection method, in which an access point (AP) makes all stations (STAs) quiet and all the STAs inspect whether a radar signal is present or not and enabled or not without being interfered with by frame transfer/reception during a quiet interval. This technique is considered to assist the procedures for dynamic frequency selection in a wireless LAN system that assists a broad-band operation channel.

There is a power-saving method, in which a terminal minimizes the operation frequency of an analog-digital converter or a digital-analog converter and a modem processor in accordance with a VHT mode, a High Throughput (HT) mode, or a legacy mode in a reception stand-by state in an awake section. This technique is considered to enhance the resource utilization rate of a high-speed wireless communication system and reduce power consumption of the terminal or the like.

There is a primary channel selection method, in which a primary channel in a first Basic Service Set (BSS) is selected so as to be adjacent to a primary channel in a second BSS. This technique is considered to contribute to avoiding a mutual collision between the first and second BSSs due to channels in the first and second BSSs at least partially overlapping each other.

Related techniques are disclosed in U.S. Patent Application Publication No. 2014/0050156, Japanese National Publication of International Patent Application No. 2014-522196, Japanese Laid-open Patent Publication No. 2015-80230, and Japanese National Publication of International Patent Application No. 2013-541881.

### SUMMARY

According to an aspect of the invention, a communication controller includes a memory, and processor circuitly coupled to the memory and configured to calculate an expected value of an interference amount in a first wireless communication apparatus and a second wireless communication apparatus on the basis of a first use probability in a first frequency bandwidth, a second use probability in a second frequency bandwidth, the first and second frequency bandwidth being calculated on the basis of the traffic of a terminal apparatus, and received power of a signal received by the first wireless communication apparatus from the second wireless communication apparatus, assign a first or second channel to the first and second wireless communication apparatuses on the basis of the expected value, and notify the first or second channel which has been assigned to the first and second wireless communication apparatuses.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the configuration of a wireless communication system;

FIG. 2 illustrates an example of the configuration of the wireless communication system;

FIG. 3 illustrates an example of the configuration of an access point (AP) and a terminal;

FIG. 4 illustrates an example of the configuration of a control station;

FIG. 5 is a flowchart illustrating an example of the overall operation;

FIG. 6 is a flowchart illustrating an example of calculation of a demanded use rate;

FIGS. 7A to 7C illustrate examples of the demanded use rate;

FIG. 8A illustrates an example of the correlation between a bandwidth and a transmission rate, and FIG. 8B illustrates an example of calculation of the demanded use rate;

FIG. 9A illustrates an example of an expected interference amount value, and FIG. 9B illustrates an example of calculation of the expected interference amount value;

FIGS. 10A and 10B illustrate examples of an interference weight;

FIG. 11 illustrates an example of a table of the interference weight T;

FIGS. 12A and 12B illustrate examples of the demanded use rate;

FIG. 13A illustrates an example of the demanded use rate, and FIG. 13B illustrates an example of the interference weight;

FIG. 14A illustrates an example of an AP interference amount, and FIG. 14B illustrates an example of a system interference amount;

FIGS. 15A and 15B illustrate examples of a channel assignment pattern;

FIG. 16 is a flowchart illustrating an example of calculation of the demanded use rate;

FIG. 17 illustrates an example of calculation of the demanded use rate;

FIG. 18 illustrates an example of the configuration of a terminal and an AP;

FIG. 19 illustrates an example of the configuration of a control station;

FIG. 20 illustrates an example of the hardware configuration of the terminal;

FIG. 21 illustrates an example of the hardware configuration of the AP;

FIG. 22 illustrates an example of the hardware configuration of the control station; and

FIG. 23 illustrates an example of a channel utilization pattern.

### DESCRIPTION OF EMBODIMENTS

In the technique described above, an access point arranges channels such as the primary channel based on the RSSI from other access points, for example. However, the channels are not arranged in consideration of the traffic amount.

The traffic amount for terminal apparatuses occasionally differs among the terminal apparatuses, and the traffic amount for access points also occasionally differs among the access points. In the case where there is an imbalance in traffic amount among the access points, there may be an imbalance in use of channels or interference among the access points, depending on the arrangement of the primary channel. In such a case, the utilization efficiency for all the access points may be lowered, which may accordingly lower the performance of the entire wireless communication system.

It is desirable to provide a communication controller, a wireless communication system, and a channel assignment method that improve the performance of the entire wireless communication system even in the case where there is an imbalance in traffic amount.

Embodiments of the present disclosure will be described below. The following embodiments do not limit the disclosed technique. The embodiments may be combined with each other as appropriate unless a contradiction occurs in process content.

The terms used and the technical contents described in the specifications as standards related to communication by the IEEE or the like may be used, as appropriate, as the terms used and the technical contents described herein.

### First Embodiment

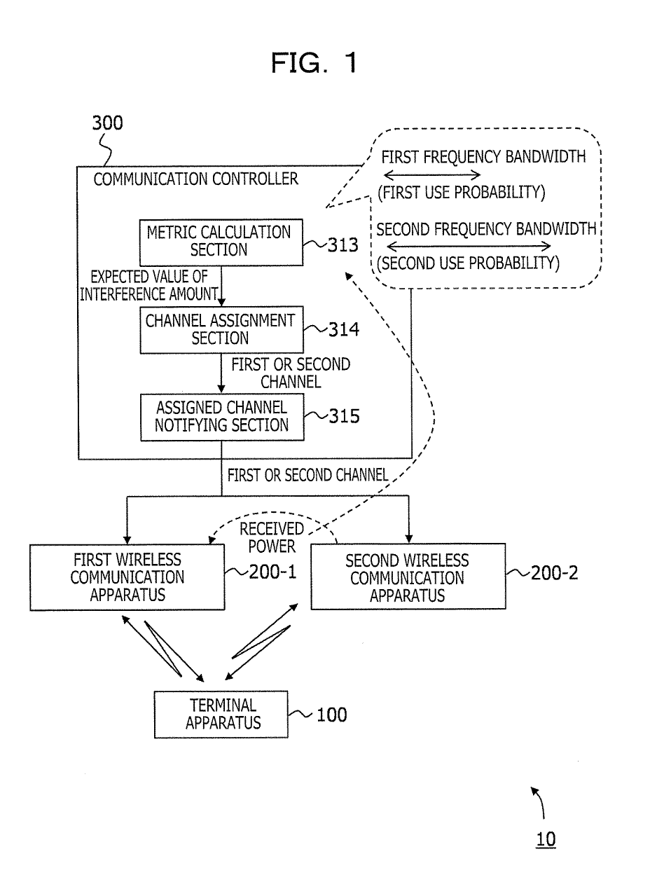

FIG. 1 illustrates an example of the configuration of a wireless communication system 10 according to a first embodiment. The wireless communication system 10 includes a terminal apparatus 100, first and second wireless communication apparatuses 200-1 and 200-2, and a communication controller 300.

The terminal apparatus 100 is a wireless communication apparatus that performs wireless communication with the first and second wireless communication apparatuses 200-1 and 200-2, for example. Examples of the terminal apparatus 100 include a feature phone, a smartphone, a tablet terminal, a personal computer, and a gaming device.

Examples of the first and second wireless communication apparatuses 200-1 and 200-2 include a wireless communication apparatus that performs wireless communication with the terminal apparatus 100 within its own communication range. Examples of the first and second wireless communication apparatuses 200-1 and 200-2 include an access point.

The communication controller 300 includes a metric calculation section 313, a channel assignment section 314, and an assigned channel notifying section 315.

The metric calculation section 313 calculates an expected value of an interference amount in the first and second wireless communication apparatuses 200-1 and 200-2 based on first and second use probabilities and the received power of a signal received by the first wireless communication apparatus 200-1 from the second wireless communication apparatus 200-2. The first and second use probabilities represent the respective use probabilities of first and second frequency bandwidths calculated based on the traffic amount for the terminal apparatus 100.

The channel assignment section 314 assigns a first or second channel to the first and second wireless communication apparatuses 200-1 and 200-2 based on the expected value of the interference amount.

The assigned channel notifying section 315 notifies the first and second wireless communication apparatuses 200-1 and 200-2 of the first or second channel which has been assigned.

In this way, the communication controller 300 calculates the expected value of the interference amount in consideration of not only the reception power (or interference power) received by the first wireless communication apparatus 200-1 from the second wireless communication apparatus 200-2 but also the use probabilities of the bandwidths which match the traffic amount for the terminal apparatus 100.

Thus, the communication controller 300 may calculate the expected value of the interference amount in consideration of the traffic amounts for the first and second wireless communication apparatuses 200-1 and 200-2 which are connected to the terminal 100.

Hence, in the communication controller 300, even in the case where there is an imbalance in traffic amount between the first and second wireless communication apparatuses 200-1 and 200-2, the expected value of the interference amount is calculated in consideration of such an imbalance.

In this case, the communication controller 300 assigns the first or second channel based on the expected value of the interference amount. For example, the communication controller 300 may perform assignment so as to meet a predetermined condition, such as assigning the first or second channel such that the expected value is equal to or less than a threshold or assigning the first or second channel such that the maximum value of the expected value is minimized.

Thus, the communication controller 300 may make the utilization efficiency of the first or second channel equal to or less than a threshold, for example, by assigning the first or second channel which meets the predetermined condition even in the case where there is an imbalance in traffic between the first and second wireless communication apparatuses 200-1 and 200-2.

Hence, it is possible to improve the performance of the entire wireless communication system 10 through the channel assignment by the communication controller 300.

### Second Embodiment

Next, a second embodiment will be described.

<Configuration Example of Wireless Communication System>

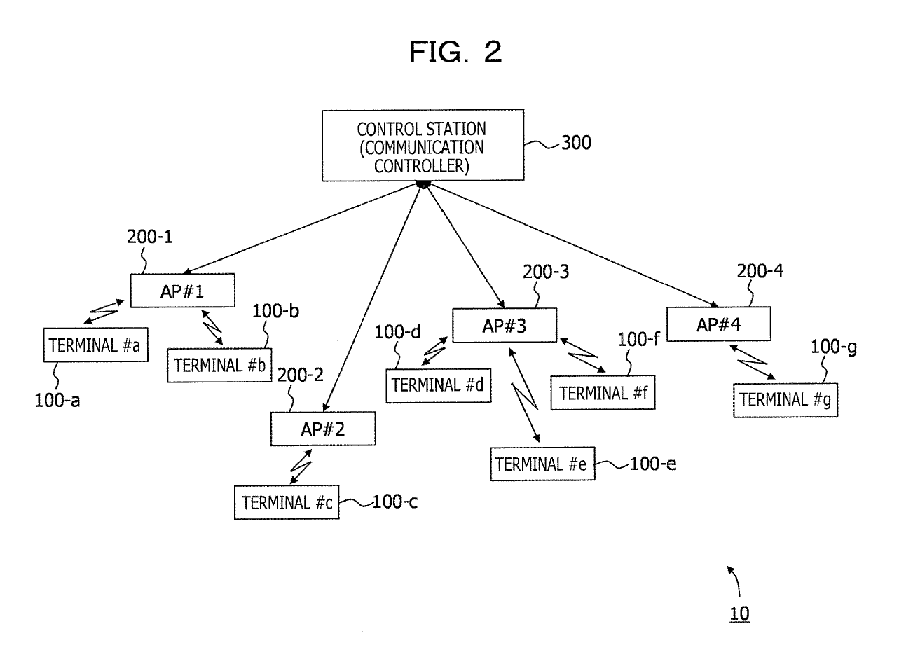

FIG. 2 illustrates an example of the configuration of the wireless communication system 10. The wireless communication system 10 includes terminal apparatuses (hereinafter occasionally referred to as “terminals”) 100-a to 100-g, access points (APs) 200-1 to 200-4, and a control station apparatus (hereinafter occasionally referred to as a “control station”) 300.

The communication controller 300 in the first embodiment corresponds to the control station apparatus 300, for example. The first and second wireless communication apparatuses 200-1 and 200-2 in the first embodiment correspond to the APs 200-1 and 200-2, for example. The terminal apparatus 100 in the first embodiment corresponds to the terminal 100-a, for example.

The terminals 100-a to 100-g are wireless communication apparatuses that may perform wireless communication with the APs 200-1 to 200-4. Examples of the terminals 100-a to 100-g include a feature phone, a smartphone, a tablet terminal, a personal computer, and a gaming device. The terminals 100-a to 100-g may receive a variety of services, such as a talk service and a web browsing service, provided via the APs 200-1 to 200-4, for example.

The APs 200-1 to 200-4 are wireless communication apparatuses that may perform wireless communication with the terminals 100-a to 100-g within their own communicable ranges. The APs 200-1 to 200-4 perform wireless communication with the terminals 100-a to 100-g using a wireless Local Area Network (LAN) (or a Wireless Local Area Network (WEAN)) as a wireless access scheme, for example. Examples of the wireless LAN include IEEE 802.11ac. The APs 200-1 to 200-4 set a wireless channel using dynamic bandwidth control. In this case, the APs 200-1 to 200-4 receive list information that indicates a channel assignment pattern of the primary channel from the control station 300. The APs 200-1 to 200-4 perform the dynamic bandwidth control based on the received list information. An example of the dynamic bandwidth control will be described in the “Operation Example” section.

The APs 200-1 to 200-4 may be connected to a network via the control station 300 or directly, and exchange data or the like with a server connected to the network, for example. In this case, the APs 200-1 to 200-4 may convert data received from a server or the like into a wireless signal, transmit the wireless signal to the terminals 100-a to 100-g, receive data or the like from a wireless signal transmitted from the terminals 100-a to 100-g, and transmit the received data to a server or the like.

The control station 300 is connected to a plurality of APs 200-1 to 200-4, and controls APs 200-1 to 200-4, for example. In the second embodiment, the control station 300 calculates an expected value of an interference amount for the entirety of the APs 200-1 to 200-4, and decides an assignment pattern of the primary channel based on the expected value. The control station 300 generates list information that indicates the decided channel assignment pattern of the primary channel, and transmits the list information to each of the APs 200-1 to 200-4. The calculation of the expected interference amount value and the decision of the channel assignment pattern will be described in detail in the “Operation Example” section.

In the example of the wireless communication system 10 illustrated in FIG. 2, the AP 200-1 performs wireless communication with the terminals 100-a and 100-b, and the AP 200-2 performs wireless communication with the terminal 100-c. In addition, the AP 200-3 performs wireless communication with the terminals 100-d to 100-f, and the AP 200-4 performs wireless communication with the terminal 100-g. The example of FIG. 2 is exemplary, and the wireless communication system 10 may include one or a plurality of terminals and one or a plurality of APs, and the terminals and the APs may perform wireless communication.

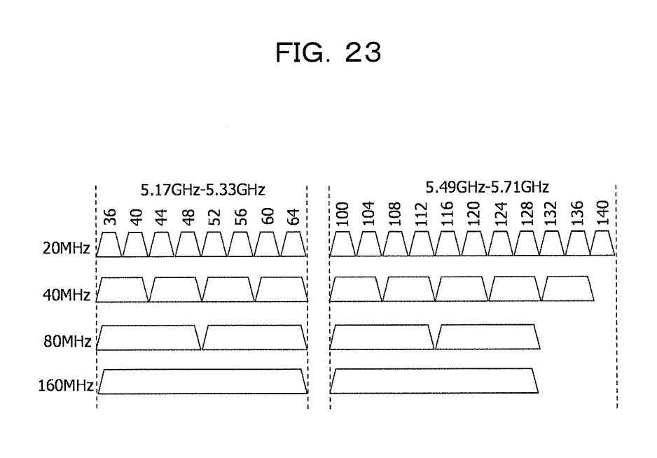

In the following description, the primary channel will be occasionally referred to as a “P20 channel”, for example. In the example of FIG. 23, a channel with an IEEE channel number of “36” and a channel with an IEEE channel number of “40” may be the P20 channel. In addition, the IEEE channel number will be occasionally referred to as a “channel number”, for example. Further, a frequency band having a certain width about a center frequency will be occasionally referred to as a “channel”, for example. However, the channel and the frequency bandwidth will be occasionally used without distinction. Furthermore, the frequency bandwidth will be occasionally referred to as a “bandwidth”.

Next, an example of the configuration of the terminal 100-a, the AP 200-1, and the control station 300 will be described sequentially.

<Configuration Example of Terminal and AP>

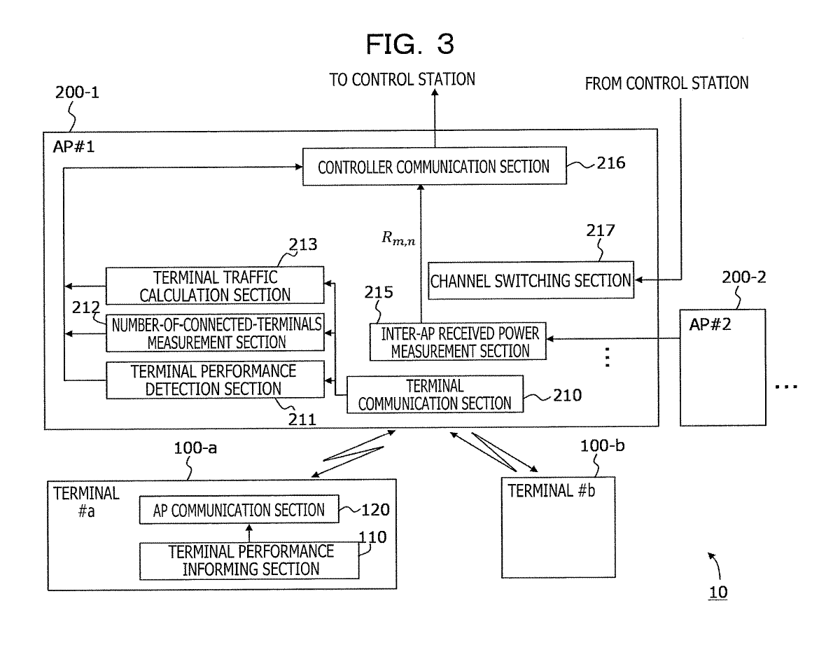

FIG. 3 illustrates an example of the configuration of the terminal 100-a and the AP 200-1. The terminals 100-a to 100-g have the same configuration, and therefore the terminal 100-a will be described as a representative example. In addition, the APs 200-1 to 200-4 have the same configuration, and therefore the AP 200-1 will be described as a representative example.

The terminal 100-a includes a terminal performance informing section 110 and an AP communication section 120. The terminal performance informing section 110 informs the AP 200-1 of terminal performance information on the terminal itself via the AP communication section 120. The terminal performance information includes the traffic amount for the terminal 100-a, the transmission rate of the terminal 100-a, and all or a part of a transmission/reception bandwidth that may be supported by the terminal 100-a.

The traffic amount for the terminal 100-a is a data amount for a case where the terminal 100-a performs wireless communication with the AP 200-1 for a certain time, for example. Alternatively, the traffic amount for the terminal 100-a may be a statistical value (e.g. the average value) of the data amount, the data amount of a content to be downloaded, or a throughput [bps]. The traffic amount for the terminal 100-a may be a traffic amount demanded by the terminal 100-a, for example.

The transmission rate of the terminal 100-a may be a transmission rate at which the terminal 100-a may perform transmission or a transmission rate decided based on the quality of wireless communication between the terminal 100-a and the AP 200-1, for example. Alternatively, the transmission rate of the terminal 100-a may be the maximum transmission rate, the minimum transmission rate, or the average transmission rate, for example. Such a transmission rate may be decided based on the performance of the terminal 100-a, for example.

The transmission/reception bandwidth that may be supported by the terminal 100-a represents a transmission bandwidth and a reception bandwidth (or a transmission bandwidth or a reception bandwidth) that may be supported by the terminal 100-a for wireless communication with the AP 200-1, for example. Examples of the transmission/reception bandwidth that may be supported include 20 MHz, 40 MHz, 80 MHz, and 160 MHz. Such a bandwidth may be decided based on the performance of the terminal 100-a, for example.

The traffic amount, the transmission rate, and the transmission/reception bandwidth that may be supported are held in a memory of the terminal 100-a, and the terminal performance informing section 110 may read such information from the memory and transmit the information, for example. Alternatively, all or a part of such information may be measured by the terminal 100-a.

The AP communication section 120 transmits the terminal performance information, which is received from the terminal performance informing section 110, to the AP 200-1 (or informs the AP 200-1 of such terminal performance information). In addition, the AP communication section 120 may exchange audio data, visual data, or the like with the AP 200-1, for example. The AP communication section 120 may convert the data, the terminal performance information, or the like into a wireless signal and transmit the wireless signal to the AP 200-1, and receive a wireless signal transmitted from the AP 200-1 and extract data or the like from the received wireless signal.

The AP 200-1 includes a terminal communication section 210, a terminal performance detection section 211, a number-of-connected-terminals measurement section 212, a terminal traffic calculation section 213, an inter-AP received power measurement section 215, a controller communication section 216, and a channel switching section 217.

The terminal communication section 210 exchanges a wireless signal with the terminals 100-a and 100-b. The terminal communication section 210 receives a wireless signal transmitted from the terminals 100-a and 100-b, and extracts terminal performance information, data, or the like from the received wireless signal. In addition, the terminal communication section 210 receives data or the like from a server or the like, converts such data into a wireless signal, and transmits the wireless signal to the terminals 100-a and 100-b, for example.

In addition, the terminal communication section 210 performs wireless communication with the terminals 100-a and 100-b using the P20 channel which is received from the channel switching section 217, for example. In this case, the terminal communication section 210 performs dynamic bandwidth control utilizing the channel utilization pattern (e.g. FIG. 23), for example. An example of the dynamic bandwidth control will be described in the “Operation Example” section.

The terminal performance detection section 211 receives the terminal performance information from the terminal communication section 210, and extracts connected terminal information on the terminals 100-a and 100-b, which are connected to the AP 200-1, based on the received connected terminal information. The terminal performance detection section 211 outputs the connected terminal information on the terminals 100-a and 100-b to the controller communication section 216. In this case, the terminal performance detection section 211 may output the terminal performance information, which is received from the terminal communication section 210, as it is to the controller communication section 216 as the connected terminal information.

The number-of-connected-terminals measurement section 212 measures the number of terminals 100-a and 100-b connected to the AP 200-1. For example, the number-of-connected-terminals measurement section 212 may measure the number of terminals as follows. That is, the AP 200-1 performs an authentication process at the time of connection with the terminals 100-a and 100-b. In this event, the terminal communication section 210 exchanges information related to the authentication with the terminals 100-a and 100-b. When the authentication is completed, the terminal communication section 210 outputs a completion notification to the number-of-connected-terminals measurement section 212. The number-of-connected-terminals measurement section 212 measures the number of terminals by counting the number of completion notifications. Alternatively, the number-of-connected-terminals measurement section 212 may count the number of terminals based on an authentication table. The authentication table is prepared by the terminal communication section 210 after the authentication process is completed. In either case, the number-of-connected-terminals measurement section 212 outputs the number of terminals which has been measured to the controller communication section 216.

The terminal traffic calculation section 213 monitors the status of communication between the AP 200-1 and the terminals 100-a and 100-b, and calculates the demanded traffic for the terminals 100-a and 100-b. The terminal traffic calculation section 213 may calculate the demanded traffic based on the data amount of data exchanged between the AP 200-1 and the terminals 100-a and 100-b, for example. Alternatively, the terminal traffic calculation section 213 may use the traffic amount for the terminals 100-a and 100-b, which is extracted from the terminal performance information, as the demanded traffic for the terminals 100-a and 100-b. The terminal traffic calculation section 213 outputs the demanded traffic to the controller communication section 216.

The inter-AP received power measurement section 215 measures a received power value between the APs based on a signal received from the other APs 200-2, 200-3, . . . . When a wireless signal is received from the AP 200-2, for example, the inter-AP received power measurement section 215 measures inter-AP received power between the AP 200-1 and the AP 200-2 based on the received wireless signal (or the received signal). Meanwhile, when a wireless signal is received from the AP 200-3, for example, the inter-AP received power measurement section 215 measures an inter-AP received power value between the AP 200-1 and the AP 200-3 based on the wireless signal (or the received signal). The inter-AP received power measurement section 215 outputs the inter-AP received power, which has been measured, to the controller communication section 216. Examples of the received power include the RSSI, a Signal to Interference plus Noise Ratio (SINR), and the power of the wireless signal.

The controller communication section 216 transmits the terminal performance information, the number of connected terminals, the demanded traffic, and the inter-AP received power to the control station 300. The controller communication section 216 generates a packet that includes such information, and transmits the generated packet to the control station 300, for example.

The channel switching section 217 receives the list information on the P20 channel transmitted from the control station 300, extracts the P20 channel for the AP 200-1 from the list information, and sets the P20 channel as the P20 channel for the AP 200-1. In this case, in the case where the P20 channel has already been set, the channel switching section 217 switches from the P20 channel which has already been set to the P20 channel included in the list information. For example, the channel switching section 217 outputs the P20 channel, which has been set or after the switching, to the terminal communication section 210, and the terminal communication section 210 performs wireless communication with the terminals 100-a and 100-b using the P20 channel through the wireless LAN.

<Configuration Example of Control Station>

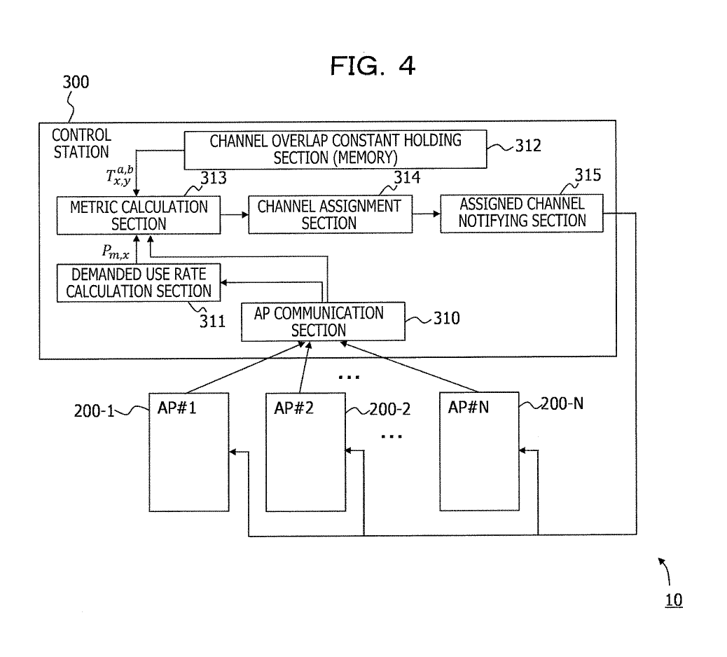

FIG. 4 illustrates an example of the configuration of the control station 300. The control station 300 includes an AP communication section 310, a demanded use rate calculation section 311, a channel overlap constant holding section 312, a metric calculation section 313, a channel assignment section 314, and an assigned channel notifying section 315.

The AP communication section 310 receives a packet transmitted from the APs 200-1 to 200-N, and extracts the terminal performance information on the APs 200-1 to 200-N, the number of connected terminals, the demanded traffic, and the inter-AP received power from the received packet. The AP communication section 310 outputs the terminal performance information, the number of connected terminals, and the demanded traffic to the demanded use rate calculation section 311, and outputs the inter-AP received power to the metric calculation section 313.

The demanded use rate calculation section 311 calculates a demanded use rate (or a demanded use probability; hereinafter occasionally referred to as a “demanded use rate”) P for each bandwidth in the APs 200-1 to 200-4 based on the demanded traffic for the terminals 100-a to 100-g, for example. The demanded use rate P represents the use probability of a bandwidth (such as 20 MHz, 40 MHz, and 80 MHz) that meets the demanded traffic for the terminals 100-a and 100-b in the AP 200-1, for example. In this case, the demanded use rate calculation section 311 calculates the demanded use rate P also in consideration of the terminal performance information, for example. The calculation of the demanded use rate P will be described in detail in the “Operation Example” section.

The channel overlap constant holding section 312 is a memory, and holds a channel overlap constant T, for example. The channel overlap constant T represents the weight of interference in the AP 200-1 on the interfered side for a case where the AP 200-2 on the interfering side is performing transmission in a certain bandwidth during reception operation of the AP 200-1 in the certain bandwidth, for example. Hereinafter, the channel overlap constant T will be occasionally referred to as an “interference weight T”, for example. An example of the interference weight will be described in detail in the “Operation Example” section.

The metric calculation section (or expected interference amount value calculation section) 313 calculates an expected interference amount value I using the demanded use rate P and the inter-AP received power for the APs 200-1 to 200-4, for example. Specifically, the metric calculation section 313 reads the interference weight T from the channel overlap constant holding section 312, and calculates the expected interference amount value I based on the demanded use rate, the inter-AP received power, and the interference weight T, for example. The expected interference amount value I represents an expected value of an interference amount for the entirety of the APs 200-1 to 200-4 for a case where the P20 channel is assigned to the APs 200-1 to 200-4, for example. The expected interference amount value I which has been calculated will be occasionally referred to as a “metric I”, for example. The metric I will be described in detail in the “Operation Example” section.

The channel assignment section (or frequency bandwidth assignment section 314) receives the metric I which is output from the metric calculation section 313, and decides an assignment pattern of the P20 channel that meets a predetermined condition based on the received metric. In an example of the assignment pattern, the P20 channel of the AP 200-1 has a channel number of “36”, and the P20 channel of the AP 200-2 has a channel number of “44”. The assignment pattern of the P20 channel indicates which channel is used as the P20 channel in the APs 200-1 to 200-4, for example.

The assigned channel notifying section 315 prepares list information on the P20 channel based on the assignment pattern of the P20 channel which is received from the channel assignment section 314, and notifies the APs 200-1 to 200-4 of the prepared list information (or transmits the list information to the APs 200-1 to 200-4).

### Operation Example

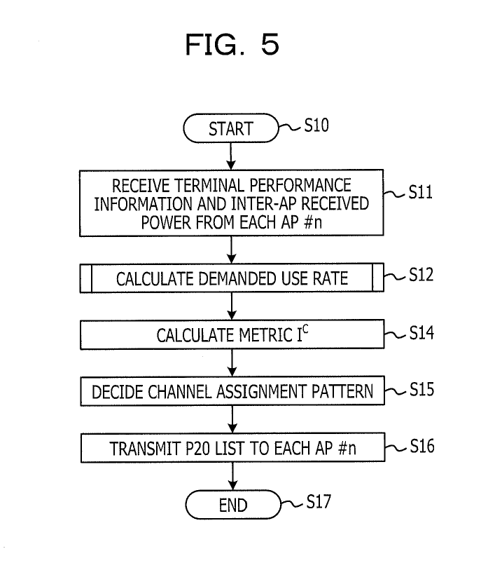

Next, an operation example will be described. FIG. 5 is a flowchart illustrating an example of operation of the control station 300. In the following description, the terminals 100-a to 100-g will be occasionally referred to as “terminals 100”, and the APs 200-1 to 200-4 will be occasionally referred to as “APs 200”.

When processing is started (S10), the control station 300 receives the terminal performance information and the inter-AP received power from each AP #n (n is an integer of 1 or more) (S11). For example, the AP communication section 310 receives the terminal performance information and the inter-AP received power transmitted from each of the APs 200-1 (AP #1) to 200-4 (AP #4).

Next, the control station 300 calculates a demanded use rate (S12). A method of calculating a demanded use rate will be described below.

<Method of Calculating Demanded Use Rate>

If a bandwidth used for wireless communication by the AP 200-n (AP #n) is defined as x MHz (x=20, 40, 80, or the like), the demanded use rate is represented as P_{n,x}. In this case, the demanded use rate at 20 MHz for the AP 200-1 (AP #1) is represented as P_{1,20}, and the demanded use rate at 40 MHz for the AP 200-2 is represented as P_{2,40}.

The demanded use rate represents the use probability at each bandwidth (e.g. 20 MHz, 40 MHz, and 80 MHz) calculated based on the traffic amount demanded from the terminal 100, for example. The demanded use rate is calculated for each of the APs 200, for example.

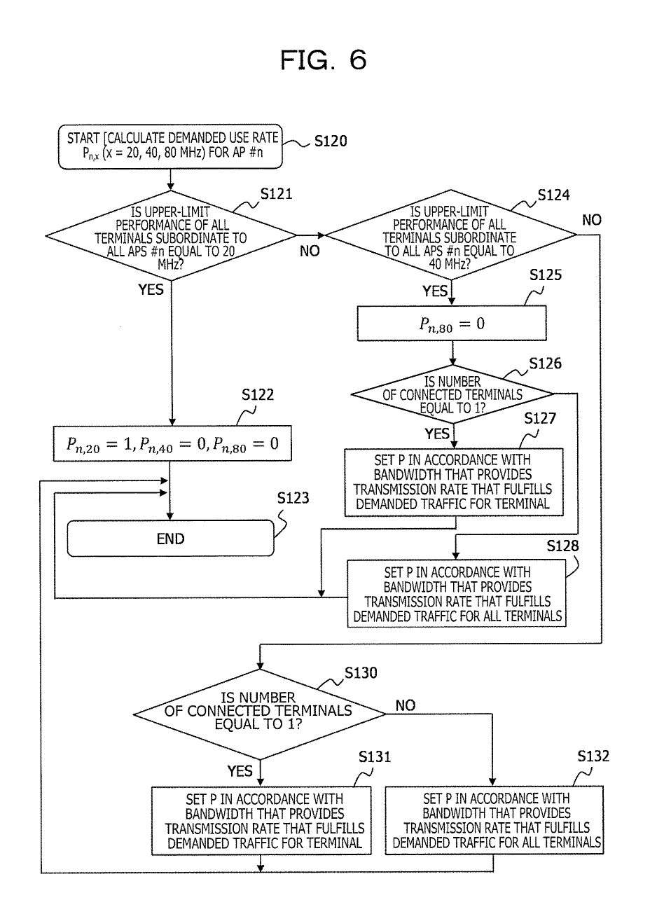

FIG. 6 is a flowchart illustrating an example of a calculation process for the demanded use rate performed by the control station 300. When a calculation process for the demanded use rate is started (S120), the control station 300 determines whether or not the upper-limit performance of all the terminals 100 that are subordinate to all the APs #n is 20 MHz (S121). For example, it is determined whether or not all the terminals 100 that are subordinate to the control station 300 perform wireless communication in a bandwidth of 20 MHz and do not perform wireless communication in a broad bandwidth such as 40 MHz and 80 MHz. For example, the demanded use rate calculation section 311 extracts a transmission/reception bandwidth that may be supported by the terminals 100 from the terminal performance information received from the AP communication section 310, and makes the above determination based on whether or not the transmission/reception bandwidth is all 20 MHz.

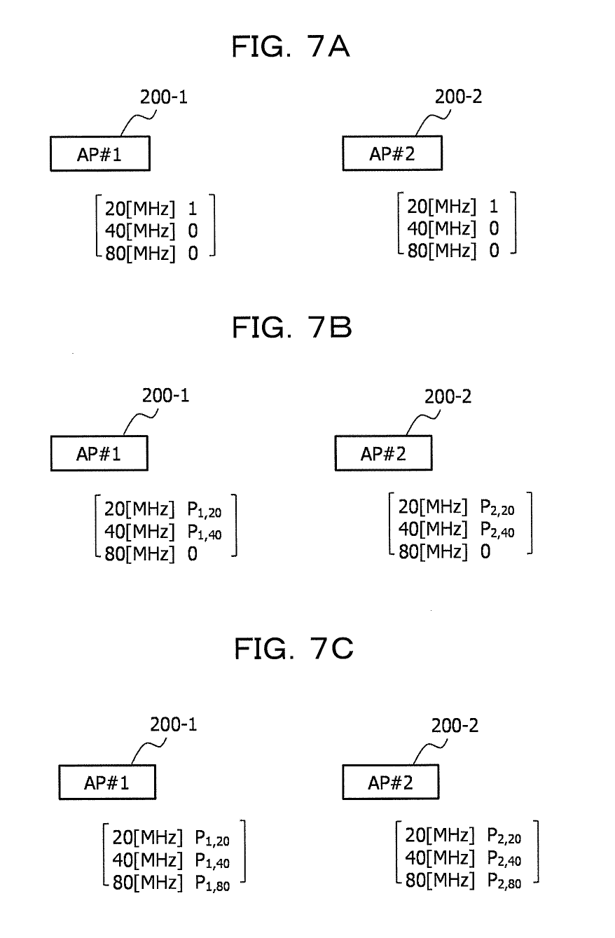

When the upper-limit performance of all the terminals 100 that are subordinate to all the APs #n is 20 MHz (Yes in S121), the control station 300 sets the demanded use rate for each of the APs #n as P_{n,20}=1, P_{n,40}=0, and P_{n,80}=0 (S122). In this case, all the terminals 100 perform wireless communication using 20 MHz, and do not perform wireless communication using 40 MHz or 80 MHz. This results in P_{n,20}=1, P_{n,40}=0, and P_{n,80}=0. FIG. 7A illustrates an example of setting of the demanded use rate for such a case. In this example, the demanded use rate calculation section 311 sets P_{1,20}=1, P_{1,40}=0, P_{1,80}=0, P_{2,20}=1, P_{2,40}=0, and P_{2,80}=0.

Returning to FIG. 6, when the demanded use rate is set (S122), the control station 300 ends the calculation process for a demanded use rate (S123).

When the upper-limit performance of all the terminals 100 that are subordinate to all the APs #n is not 20 MHz (No in S121), meanwhile, the control station 300 determines whether or not the upper-limit performance of all the terminals 100 that are subordinate to all the APs #n is 40 MHz (S124). For example, it is determined whether or not the upper-limit performance of all the terminals 100 that are subordinate to the control station 300 is 40 MHz, that is, such terminals 100 perform wireless communication in a bandwidth of 20 MHz or 40 MHz. Also in this case, the demanded use rate calculation section 311 makes the above determination based on the transmission/reception bandwidth that may be supported included in the terminal performance information, for example.

When the upper-limit performance of all the terminals 100 that are subordinate to all the APs #n is 40 MHz (Yes in S124), the control station 300 sets P_{n,80}=0 as the demanded use rate at 80 MHz (S125). In this case, all the terminals 100 may use 20 MHz or 40 MHz, and do not use 80 MHz since the upper-limit performance is 40 MHz. This results in P_{n,80}=0.

For example, the demanded use rate calculation section 311 determines the demanded use rate at 80 MHz for the AP 200-1 as P_{1,80}=0, and determines the demanded use rate at 80 MHz for the AP 200-2 as P_{2,80}=0. FIG. 7B illustrates an example of setting of the demanded use rate.

Next, returning to FIG. 6, the control station 300 determines for all the APs #n whether or not the number of connected terminals is “1” (S126). That is, the control station 300 determines whether or not the number of the terminals 100 which are connected to each of the APs #n is “1”. For example, the demanded use rate calculation section 311 makes the above determination in accordance with whether or not the number of connected terminals for each of the APs 200 received from the AP communication section 310 is “1”.

When the number of connected terminals is “1” (Yes in S126), the control station 300 sets the demanded use rate P which matches a bandwidth that provides a transmission rate that fulfills the demanded traffic for the terminal 100 (S127). In this case, the demanded use rate at 80 MHz is P_{n,80}=0 (S125). Therefore, the demanded use rate calculation section 311 calculates the demanded use rates P_{n,20} and P_{n,40} at 20 MHz and 40 MHz, respectively, for each of the APs 200, for example.

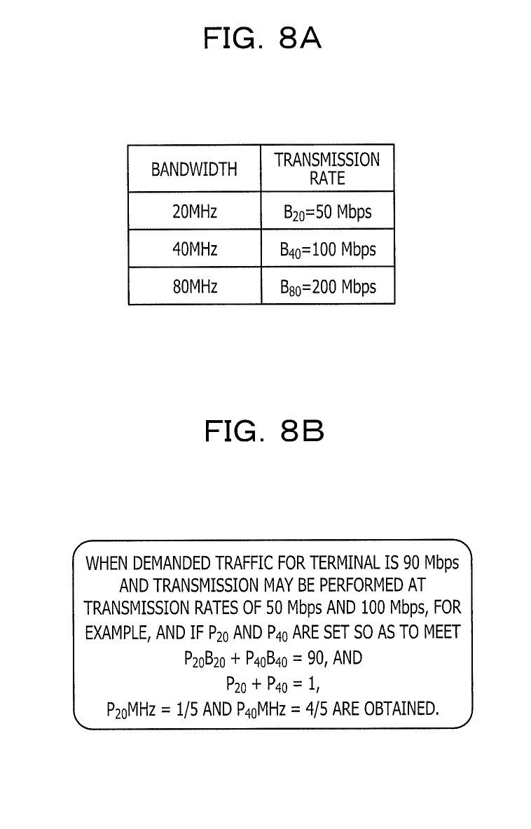

An example of a method of calculating the demanded use rates P_{n,20} and P_{n,40} in this case will be described below. FIG. 8A illustrates an example of the relationship between the bandwidth and the transmission rate. FIG. 8B illustrates an example of calculation of the demanded use rate. The demanded use rate in a certain AP 200 is conveniently represented as Pₙ.

In the case where the demanded traffic for the terminal 100 is “90 Mbps”, for example, the transmission rate of the terminal 100 at 20 MHz is defined as B₂₀, and the transmission rate of the terminal 100 at 40 MHz is defined as B₄₀. In this case, the demanded use rate calculation section 311 calculates the demanded use rates P20 and P40 by calculating P₂₀ and P40 that meet

P₂₀B₂₀+P₄₀B₄₀=90 (1), and

P₂₀+P₄₀=1 (2).

As discussed above, the transmission rate is included in the terminal performance information. The bandwidth that may be supported is also included in the terminal performance information. The demanded use rate calculation section 311 may calculate the demanded use rate by substituting the transmission rate into the formula (1), for example. Alternatively, the demanded use rate calculation section 311 may calculate the demanded use rate by calculating a transmission rate from the bandwidth that may be supported using a table and substituting the transmission rate into the formula (1), for example.

FIG. 8A illustrates an example of such a table. For example, the transmission rate B₂₀ is “50 Mbps” when the bandwidth that may be supported by the terminal 100 is “20 MHz”, and the transmission rate B₄₀ is “100 Mbps” when the bandwidth that may be supported by the terminal 100 is “40 MHz”.

As with the terminal performance information, the demanded traffic is also transmitted from each of the APs 200 to the control station 300. Then, the demanded use rate calculation section 311 calculates the demanded use rates P20 and P₄₀ by substituting the transmission rates B₂₀ and B₄₀ and the demanded traffic “90 Mbps” into the formula (1) and the formula (2).

For example, in the case where the transmission rate is as illustrated in FIG. 8A (B₂₀=50 Mbps and B₄₀=100 Mbps), P₂₀=1/5 and P₄₀=4/5 are obtained. This indicates that the demanded traffic (“90 Mbps”) for the terminal 100 may be met by determining the use probability at 20 MHz as “1/5” and the use probability at 40 MHz as “4/5” in the AP 200, for example.

The demanded use rate calculation section 311 may use

P₂₀B₂₀+P₄₀B₄₀>90 (3)

in place of the formula (1), for example.

In either case, the demanded use rate calculation section 311 calculates the demanded use rates P20 and P₄₀ by holding the formula in an internal memory or the like and reading the formula from the internal memory at the time of processing, for example. FIG. 7B illustrates an example of the demanded use rates P_{n,x} for the APs 200-1 and 200-2 after the process in S128 is performed.

Returning to FIG. 6, when the demanded use rate P is calculated (S127), the control station 300 ends the sequence of processes (S123).

When the number of connected terminals is not “1” for all the APs #n (No in S126), meanwhile, the control station 300 decides the demanded use rate P which matches a bandwidth that provides a transmission rate that fulfills the demanded traffic for all the terminals (S128). In this case, the control station 300 may calculate the demanded use rate P by summing up the demanded traffic for the terminals 100 which are connected to the APs 200 and substituting the total value into the formula (1) or the formula (3).

For example, when the demanded traffic for the terminals 100-a and 100-b which are connected to the AP 200-1 is “40 Mbps” and “50 Mbps”, respectively, the demanded use rate calculation section 311 may solve the simultaneous equations by substituting the total value “90” into the right side of the formula (1). Alternatively, the demanded use rate calculation section 311 may solve the simultaneous equations by substituting the total value “90” into the right side of the formula (3).

Then, the control station 300 ends the sequence of processes (S123).

When the upper-limit performance of all the terminals 100 that are subordinate to all the APs #n is not “40 MHz” (No in S124), meanwhile, the control station 300 determines whether or not the number of terminals connected to each of the APs #n is “1” (S130). In this case, all the terminals 100 may support transmission/reception bandwidths of 20 MHz, 40 MHz, and 80 MHz. Also in this case, the demanded use rate calculation section 311 makes the above determination based on the transmission/reception bandwidth that may be supported by each of the terminals 100 included in the terminal performance information and the number of connected terminals for each of the APs #n, for example.

When the number of connected terminals connected to each of the APs #n is “1” (Yes in S130), the control station 300 sets the demanded use rate P in accordance with a bandwidth that provides a transmission rate that fulfills the demanded traffic for the terminal 100 (S131).

For example, when the demanded traffic for the terminal 100 is “90 Mbps”, the demanded use rate calculation section 311 calculates the demanded use rates P₂₀, P₄₀, and P₈₀ that meet

P₂₀B₂₀+P₄₀B₄₀+P₈₀B₈₀=90 (4), and

P₂₀+P₄₀+P₈₀=1 (5).

B₈₀ represents a transmission rate at 80 MHz, and P₈₀ represents a demanded use rate at 80 MHz.

The demanded use rate calculation section 311 may use

P₂₀B₂₀+P₄₀B₄₀+P₈₀B₈₀>90 (6)

in place of the formula (4).

The demanded use rate calculation section 311 may use the transmission rate at 80 MHz which is transmitted from the terminal 100 to the control station 300, or may read a transmission rate corresponding to the transmission/reception bandwidth that may be supported from a table and substitute the transmission rate into the formula (4) or the formula (6), for example. For example, such a formula is held in an internal memory or the like of the demanded use rate calculation section 311, and the demanded use rate calculation section 311 reads the formula at the time of processing. FIG. 7C illustrates an example of the demanded use rates P_{n,x} for the APs 200-1 and 200-2 after the process in S131 is performed.

Then, the control station 300 ends the sequence of processes (S123).

When the number of connected terminals is not “1” (No in S130), meanwhile, the control station 300 sets the demanded use rate P in accordance with a bandwidth that provides a transmission rate that fulfills the demanded traffic for all the terminals 100 (S132). Also in this case, the control station 300 may calculate the demanded use rate P by summing up the demanded traffic for all the terminals and substituting the total value into the right side of the formula (4) or the right side of the formula (6).

Then, the control station 300 ends the sequence of processes (S123).

Through the steps described above, the control station 300 calculates the demanded use rate P_{n,x} which matches the demanded traffic for the terminal 100 for all the APs #n.

Returning to FIG. 5, when the demanded use rate is calculated (S12), the control station 300 calculates a metric I^{C} (S14). The metric calculation section 313 calculates the metric I^{C} using the following formula, for example.

$${I}^{C} = {\sum }_{m = 1}^{N} {\sum }_{n = 1}^{N} {I}_{m , n}^{{C}_{m} , {C}_{n}} \qquad ( 7 )$$

In the formula (7),

I_{m,n}^{C}^{ₘ}^{,C}^{ₙ} (8)

represents an expected value of an interference amount received by the AP #m from the AP #n (hereinafter referred to conveniently as an “expected interference amount value I_{m,n}”). In the formula, m and n represent an integer of 1 or more, and N represents the number of the APs 200.

In order to facilitate description, an expected interference amount value I_{1,2} for a case of m=1 and n=2, that is, for a case where there are two APs #1 and #2, will be described.

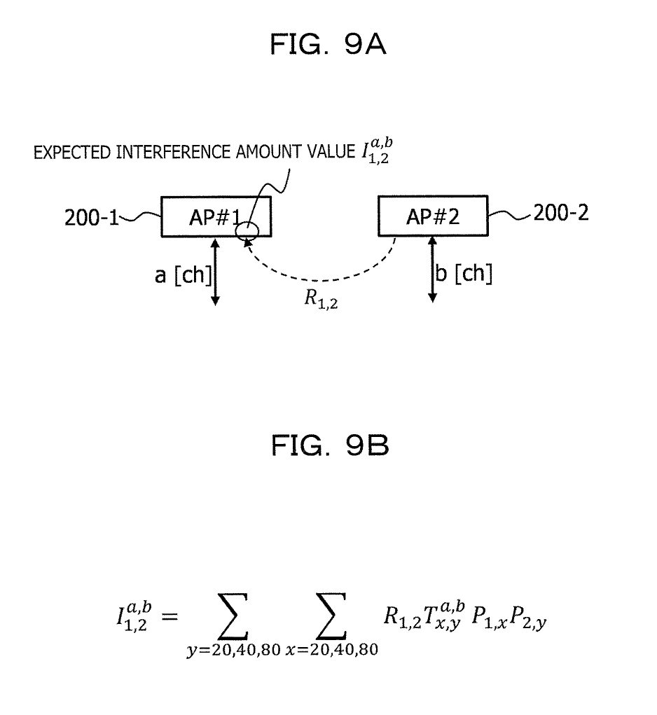

FIG. 9A illustrates an example of the expected interference amount value I_{1,2} which is received by the AP #1 from the AP #2. The AP #1 uses a channel a (e.g. with a channel number of “a”) as the P₂₀ channel. The AP #2 uses a channel b (e.g. with a channel number of “b”) as the P₂₀ channel. In this case, the expected interference amount value I_{1,2} is calculated by the following formula.

$${I}_{1 , 2}^{a , b} = {\sum }_{y = 20 , 40 , 80} {\sum }_{x = 20 , 40 , 80} {R}_{1 , 2} {T}_{x , y}^{a , b} {P}_{1 , x} {P}_{2 , y} \qquad ( 9 )$$

FIG. 9B also indicates the formula (9).

In the formula (9), R_{1,2} represents inter-AP received power (or interference power) received by the AP #1 from the AP #2. In the formula (9), in addition, T represents an interference weight (or a weight value; hereinafter occasionally referred to as an “interference weight”) for a case where the AP #2 (on the interfering side) performs transmission at y MHz using the channel b during reception operation of the AP #1 (on the interfered side) at x MHz using the channel a. Further, P_{1,x}P_{2,y} represents the product obtained by multiplying the demanded use rate P_{1,x} in the AP 200-1 (AP #1) and the demanded use rate P_{2,y} in the AP 200-2 (AP #2).

The interference weight T will be described first, and P_{1,x}P_{2,y} will be described next.

<1. Interference Weight T>

A consideration is given to a case where the AP 200-2 on the interfering side performs transmission in a bandwidth of “y” MHz using the channel “b” as the P20 channel during reception operation of the AP 200-1 on the interfered side in a bandwidth of “x” MHz using the channel “a” as the P20 channel as illustrated in FIG. 9A.

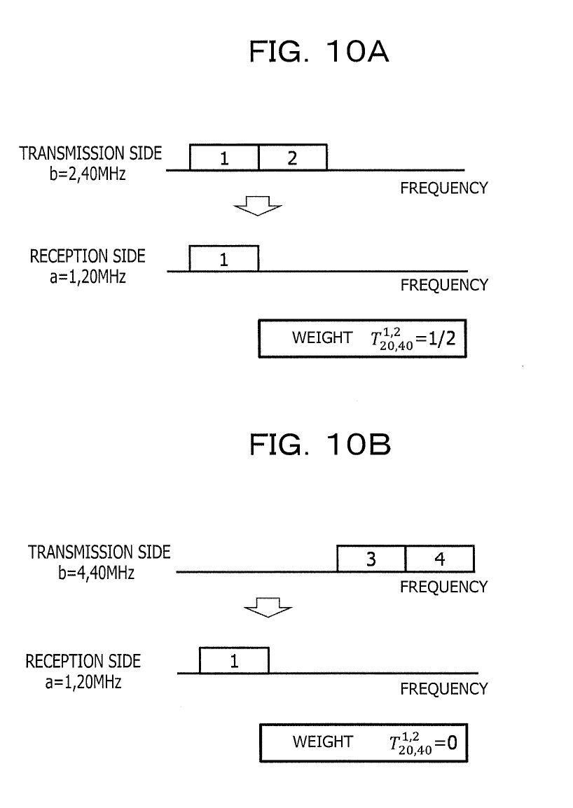

FIG. 10A illustrates an example in which the AP 200-2 on the interfering side performs transmission in a bandwidth of “40” MHz using the channel “2” as the P20 channel during reception operation of the AP 200-1 on the interfered side in a bandwidth of “20” MHz using the channel “1” as the P20 channel.

Meanwhile, FIG. 10B illustrates an example in which the AP 200-2 performs transmission in a bandwidth of “40” MHz using the channel “4” as the P20 channel during reception operation of the AP 200-1 in a bandwidth of “20” MHz using the channel “1” as the P20 channel.

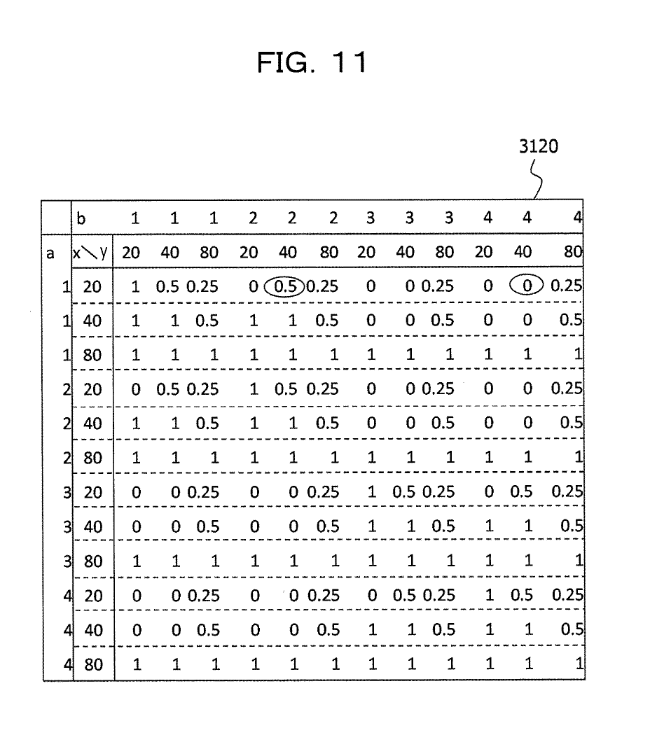

The metric calculation section 313 calculates the interference weight T using a table, for example. FIG. 11 illustrates an example of a table 3120 that stores the interference weight T. In FIG. 11, “1”, “2”, . . . in the horizontal direction in the “b” row represent the channel number set to the P20 channel in the AP 200-2, and “20”, “40”, . . . in the horizontal direction in the “x/y” row represent the transmission bandwidth in the AP 200-2. Meanwhile, “1”, “2”, . . . in the vertical direction in the “a” column represent the channel number set to the P20 channel in the AP 200-1, and “20”, “40”, . . . in the vertical direction in the “x/y” column represent the reception bandwidth in the AP 200-1.

In the example of FIG. 10A, b=2, x/y=40, a=1, and x/y=20, which derives an interference weight T of “0.5” from the table 3120 illustrated in FIG. 11. In the example of FIG. 10B, meanwhile, b=4, x/y=40, a=1, and x/y=20, which derives an interference weight T of “0”.

In this way, the interference weight T represents a weight value for interference power based on the positions of the two bandwidths used in the APs 200-1 and 200-2 for wireless communication with the terminal 100 and the positions of the two P20 channels in the APs 200-1 and 200-2, for example.

In the example of FIG. 10A, the P20 channels of the APs 200-1 and 200-2 are adjacent to each other, and the bandwidths of the APs 200-1 and 200-2 overlap each other, which results in an interference weight T of “0.5”. In the example of FIG. 10B, meanwhile, the P20 channels of the APs 200-1 and 200-2 are away from each other, and the bandwidths of the APs 200-1 and 200-2 do not overlap each other, which results in an interference weight T of “0”.

The table 3120 illustrated in FIG. 11 may be stored in a memory in the control station 300 or a memory in the metric calculation section 313, and the metric calculation section 313 may access the memory and read the corresponding interference weight T from the table 3120, for example. The table illustrated in FIG. 11 is exemplary, and the values of the interference weight T may be different from the values illustrated in FIG. 11.

<2. P_{1,x}P_{2,y}>

When the right side of the formula (9) is expanded, the following formula is obtained.

$$\begin{matrix}{\sum }_{y = 20 , 40 , 80} {\sum }_{x = 20 , 40 , 80} {R}_{1 , 2} {T}_{x , y}^{a , b} {P}_{1 , x} {p}_{2 , y} = {R}_{1 , 2} {\sum }_{y = 20 , 40 , 80} ( \begin{matrix}{T}_{20 , y}^{a , b} {P}_{1 , 20} {P}_{2 , y} + \\ {T}_{40 , y}^{a , b} {P}_{1 , 40} {P}_{2 , y} + \\ {T}_{80 , y}^{a , b} {P}_{1 , 80} {P}_{2 , y}\end{matrix} ) \\ = {R}_{1 , 2} \{ \begin{matrix}{T}_{20 , 20}^{a , b} {P}_{1 , 20} {P}_{2 , 20} + \\ {T}_{40 , 20}^{a , b} {P}_{1 , 40} {P}_{2 , 20} + \\ {T}_{80 , 20}^{a , b} {P}_{1 , 80} {P}_{2 , 20} + \\ {T}_{20 , 40}^{a , b} {P}_{1 , 20} {P}_{2 , 40} + \\ {T}_{40 , 40}^{a , b} {P}_{1 , 40} {P}_{2 , 40} + \\ {T}_{80 , 40}^{a , b} {P}_{1 , 80} {P}_{2 , 40} + \\ {T}_{20 , 80}^{a , b} {P}_{1 , 20} {P}_{2 , 80} + \\ {T}_{40 , 80}^{a , b} {P}_{1 , 40} {P}_{2 , 80} + \\ {T}_{80 , 80}^{a , b} {P}_{1 , 80} {P}_{2 , 80}\end{matrix} \}\end{matrix} \qquad ( 10 )$$

In the formula (10), P_{1,20}P_{2,20} is the product obtained by multiplying the demanded use rate at “20 MHz” in the AP #1 and the demanded use rate at “20 MHz” in the AP #2. In addition, P_{1,40}P_{2,20} is the product obtained by multiplying the demanded use rate at “40 MHz” in the AP #1 and the demanded use rate at “20 MHz” in the AP #2.

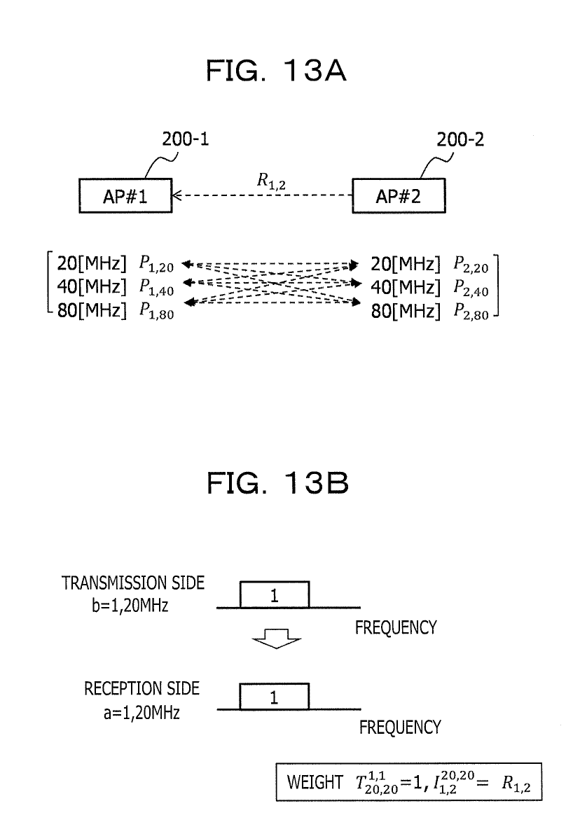

That is, P_{1,x}P_{2,y} represents a combined probability obtained by multiplying by the demanded use rate at each of “20 MHz”, “40 MHz”, and “80 MHz” in the AP 200-1 (AP #1) and the demanded use rate at each of “20 MHz”, “40 MHz”, and “80 MHz” in the AP 200-2 (AP #2), for example. FIG. 13A illustrates an example of P_{1,x}P_{2,y}.

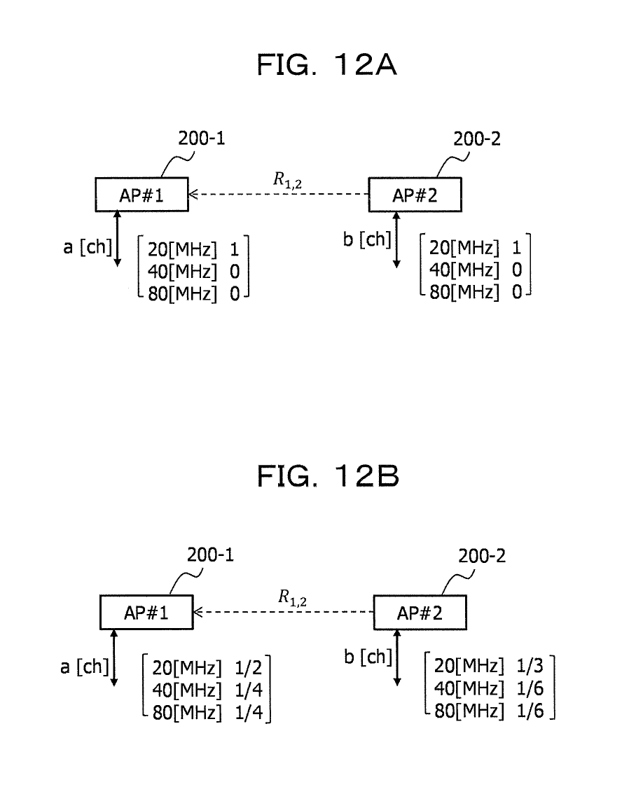

The example of FIG. 12A is considered. In this case, for both the APs 200-1 and 200-2, the demanded use rate at “20 MHz” is “1”, and the demanded use rate at the others is “0”. In this case, P_{1,20}P_{2,20} in the formula (10) is “1”, and P_{1,x}P_{2,y} with the other values is “0”. In the example of FIG. 12B, meanwhile, P_{1,20}P_{2,20}=(1/2)(1/3)=1/6, P_{1,40}P_{2,20}=(1/4)(1/3)=1/12, . . . , and P_{1,80}P_{2,80}=(1/4)(1/6)=1/24.

In the example of FIG. 12A, the expected interference amount value I_{1,2} is represented by the following formula using the formula (9) or the formula (10).

I_{1,2}^{a,b}=R_{1,2}T_{20,20}^{a,b} (11)

A consideration is given to a case where both the AP 200-1 (AP #1) and the AP 200-2 (AP #2) utilize a channel with a channel number of “1” as the P20 channel. In this case, an interference weight T of “1” is obtained from the table 3120 (e.g. FIG. 11). Thus, the expected interference amount value I_{1,2} for this case is indicated by the following formula.

I_{1,2}^{1,1}=R_{1,2} (12)

That is, when both the AP #1 and the AP #2 use a channel with a channel number of “1” as the P20 channel and the demanded use rate at “20 MHz” in both the AP #1 and the AP #2 is “1” (when 40 MHz or 80 MHz is not used), the expected interference amount value I_{1,2} is received power R_{1,2} received by the AP #1 from the AP #2. FIG. 13B illustrates an example for this case.

In other words, the expected interference amount value I_{1,2} which is indicated in the formula (9) or the formula (10) may be considered as the received power (or interference power) R_{1,2} which is received by the AP #1 from the AP #2 with the use probability at each bandwidth in the AP #1 and the AP #2 and the proportion of overlap of the P20 channels taken into consideration, for example.

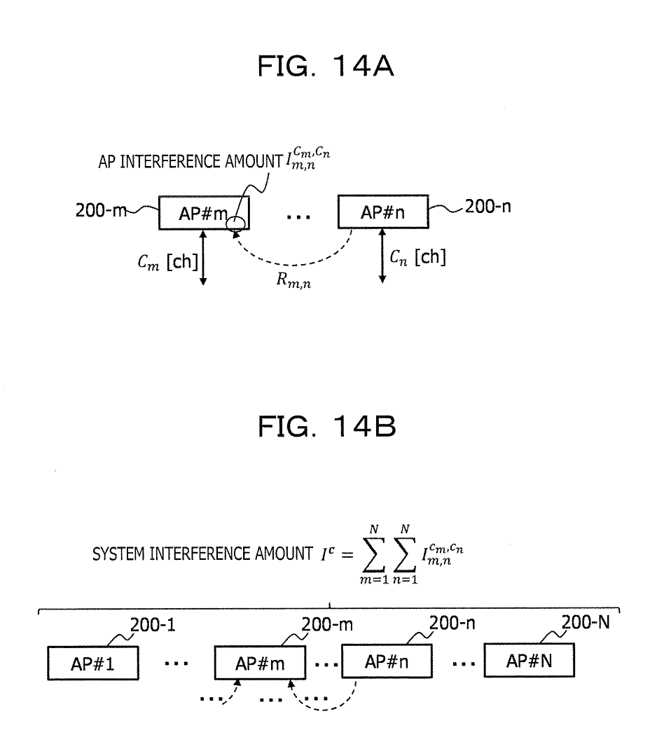

The expected interference amount value I_{1,2} for a case of m=1 and n=2 has been described above. From the above, the formula (8) represents the expected interference amount value I_{m,n} which is received by the AP #m from the AP #n. FIG. 14A illustrates an example of illustration of the formula (8).

Then, a focus is placed on the formula (7) for the metric I^{C}. FIG. 14B illustrates an example of the metric I^{C} which is indicated by the formula (7). The AP #m receives interference from APs other than the AP #n. The total of the expected interference amount values for the interference received by the AP #m from the other APs may be calculated by calculating expected interference amount values I for the interference received from the other APs in the same manner as for the AP #n and summing up such expected interference amount values I.

Then, the expected interference amount value I for all the APs from the AP #1 to the AP #N may be calculated by repeating such calculation of the expected interference amount value for the AP #1 to the AP #N. The expected interference amount value I which is calculated for all the APs 200 is used as the metric I^{C}, for example. The metric I^{C} represents an expected value of an interference amount for the entirety of the AP #1 to the AP #N, for example.

Returning to FIG. 5, when the metric I^{C} is calculated as described above (S14), the control station 300 decides a channel assignment pattern (S15).

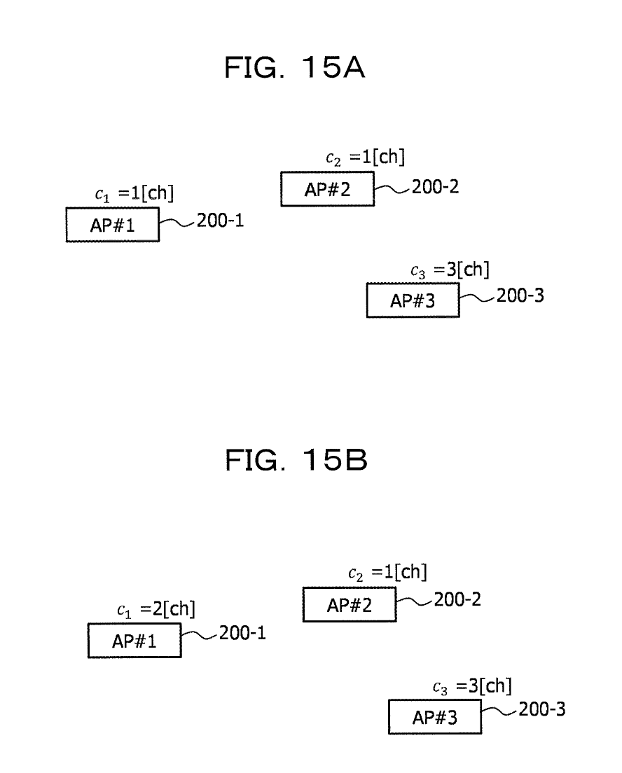

FIGS. 15A and 15B illustrate examples of the channel assignment pattern. The P20 channel of the AP 200-1 (AP #1) is defined as c₁, the P20 channel of the AP 200-2 (AP #2) is defined as c₂, and the P20 channel of the AP 200-N (AP #N) is defined as c_{N}, for example. In this case, the channel assignment pattern may be represented as c₁, c₂, . . . , c_{N}. In the example of FIG. 15A, c₁, c₂, c₃=1, 1, 3. In the example of FIG. 15B, c₁, c₂, c₃=2, 1, 3. Regarding the channel assignment pattern, in the case where the APs 200-1 and 200-2 are adjacent to each other, for example, P20 channels with the same channel number may be assigned to the APs 200-1 and 200-2, or P20 channels with different channel numbers may be assigned to the APs 200-1 and 200-2, in consideration of interference.

The channel assignment section 314 performs the following calculation, for example. That is, the channel assignment section 314 outputs channel assignment patterns c₁, c₂, . . . , c_{N} obtained by variously changing the channel assignment pattern c₁, c₂, . . . , c_{N} to the metric calculation section 313. The metric calculation section 313 calculates metrics I^{C} for the various channel assignment patterns c₁, c₂, . . . , c_{N}, and outputs the calculated metrics I^{C} to the channel assignment section 314. The channel assignment section 314 decides (or discovers) a channel assignment pattern c₁, c₂, . . . , c_{N} that meets a predetermined condition for each of the metrics I^{C} for the variously changed channel assignment patterns c₁, c₂, . . . , c_{N}. Examples of such a discovery technique include an existing optimization method, mathematical programming, M-algorithm, and an exhaustive search method. The predetermined condition may be a simple comparison with a threshold, a fact that the maximum value of an expected value (e.g. an expected value obtained by summing up the values of the formula (8) with n=1 to N) of an interference amount for the APs 200 is minimized, a fact that the total value (e.g. the metric I^{C}) of the expected value of the interference amount for the APs 200 is minimized, or the like.

Returning to FIG. 5, when the channel assignment pattern is decided (S15), the control station 300 transmits a P20 list to the APs 200 (or notifies the APs 200 of the P20 list) (S16). For example, the channel assignment section 314 outputs the decided channel assignment pattern c₁, c₂, . . . , c_{N} to the assigned channel notifying section 315, and the assigned channel notifying section 315 makes a list of the channel assignment pattern c₁, c₂, . . . , c_{N} of the P20 channel, and notifies all the APs #n of the list.

Then, the control station 300 ends the sequence of processes (S17).

For example, when the channel assignment pattern c₁, c₂, . . . , c_{N} of the P20 channel is received, the AP 200-1 performs wireless communication with the terminals 100-1 and 100-2 with reference to c₁ which is assigned as the P20 channel. In the case where c₁ is a channel with a channel number of “36”, the AP 200-1 performs the following process, for example. That is, the AP 200-1 sends an RTS signal corresponding to channels with channel numbers of “36” to “64”, and receives a CTS signal as a response signal. When the received CTS signal is a CTS signal corresponding to “36”, the AP 200-1 performs wireless communication in a bandwidth of 20 MHz using “36”. In this case, in the case where the AP 200-1 performs wireless communication in a bandwidth of 40 MHz, such wireless communication may be performed if a CTS signal corresponding to a channel number of “40” may be received, and wireless communication in a bandwidth of 40 MHz may not be performed if such a CTS signal may not be received. Also for a bandwidth of 80 MHz, the AP 200-1 may perform wireless communication in a bandwidth of 80 MHz when a CTS signal corresponding to channel numbers of “36” to “48” is received. The APs 200-1 to 200-4 may perform wireless communication in an expanded bandwidth using such an RTS/CTS protocol. Such an RTS/CTS protocol is occasionally referred to as “carrier sense control”, for example.

In the second embodiment, in this way, the communication controller 300 calculates the expected value I of the interference amount in consideration of not only the reception power (or interference power) R between the APs 200 but also the use probability P in a bandwidth that matches the traffic amount for the terminal 100. Thus, the control station 300 calculates the expected value I of the interference amount also in consideration of the traffic amount for the APs 200 which are connected to the terminal 100. Hence, even in the case where there is an imbalance in traffic amount among the APs 200, the control station 300 may calculate the expected value I of the interference amount with such an imbalance taken into consideration. In this case, the control station 300 may decide a channel assignment pattern that meets a predetermined condition, such as a channel assignment pattern that makes the expected value equal to or less than a threshold or a channel assignment pattern that minimizes the maximum value of the expected value, for example, based on the expected value I of the interference amount. The control station 300 may also decide a channel assignment pattern that improves the performance of the entire wireless communication system 10, for example, using such a channel assignment pattern that meets a predetermined condition. Thus, the control station 300 may improve the performance of the entire wireless communication system 10 even in the case where there is an imbalance in traffic among the APs 200.

In calculating the metric I^{C}, the interference weight T is also taken into consideration as indicated by the formula (9). Thus, the control station 300 takes not only the received power between the APs 200 but also the position and the bandwidth of the P20 channel between the APs 200 into consideration. Hence, the control station 300 may calculate an expected interference amount value based on interference power which is accurate.

### Third Embodiment

Next, a third embodiment will be described. In the second embodiment, the demanded traffic amount is measured by the terminal 100. The demanded traffic amount may be measured by the AP 200, for example. The terminal traffic calculation section 213 of the AP 200 may calculate the demanded traffic based on the data amount of data exchanged with the terminal 100, for example.

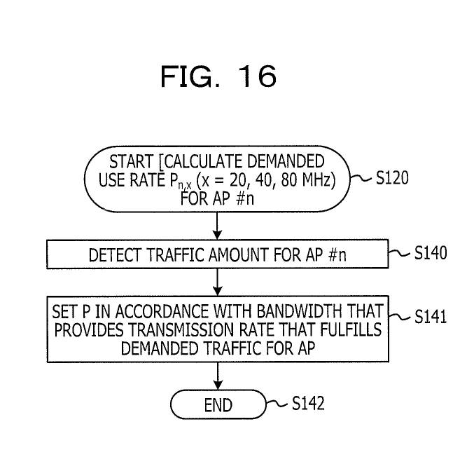

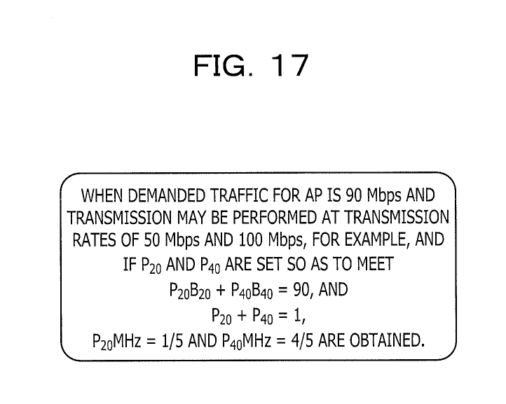

FIG. 16 is a flowchart illustrating an example of calculation of the demanded use rate. FIG. 17 illustrates an example of calculation of the demanded use rate.

The demanded use rate calculation section 311 of the control station 300 calculates the demanded traffic amount (S140). In the case where one terminal 100 is connected to the AP #n, the demanded traffic amount for the one terminal 100 may be calculated. In the case where a plurality of terminals 100 are connected to the AP #n, the total of the demanded traffic amounts for the terminals 100 may be calculated.

Then, the demanded use rate calculation section 311 calculates the demanded use rate by calculating the use rate in a bandwidth that matches the demanded traffic amount (S141, FIG. 17) as in the second embodiment, for example.

### Fourth Embodiment

In a fourth embodiment, the demanded use rate is calculated by the AP 200. The fourth embodiment may be implemented also in the second and third embodiments, for example.

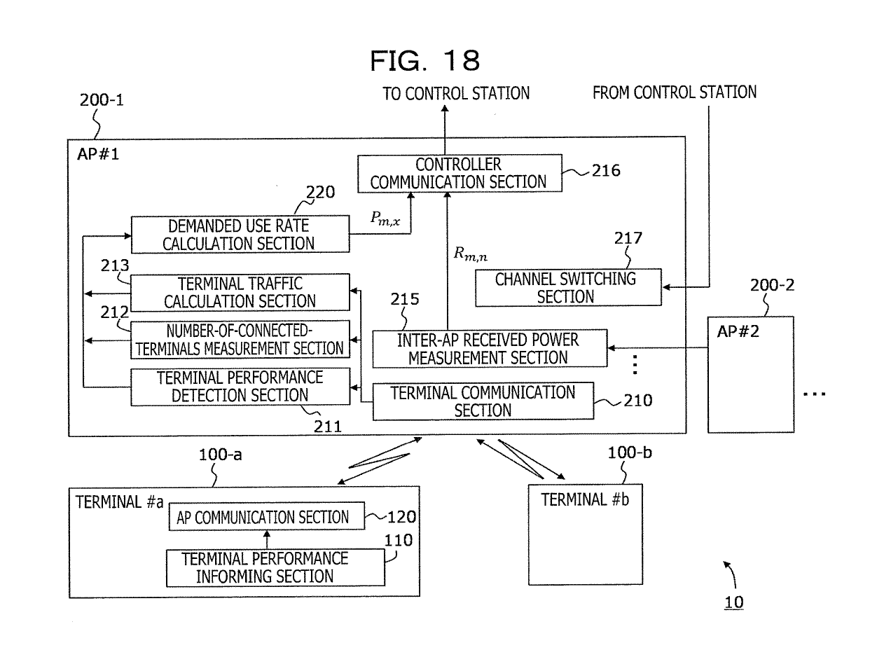

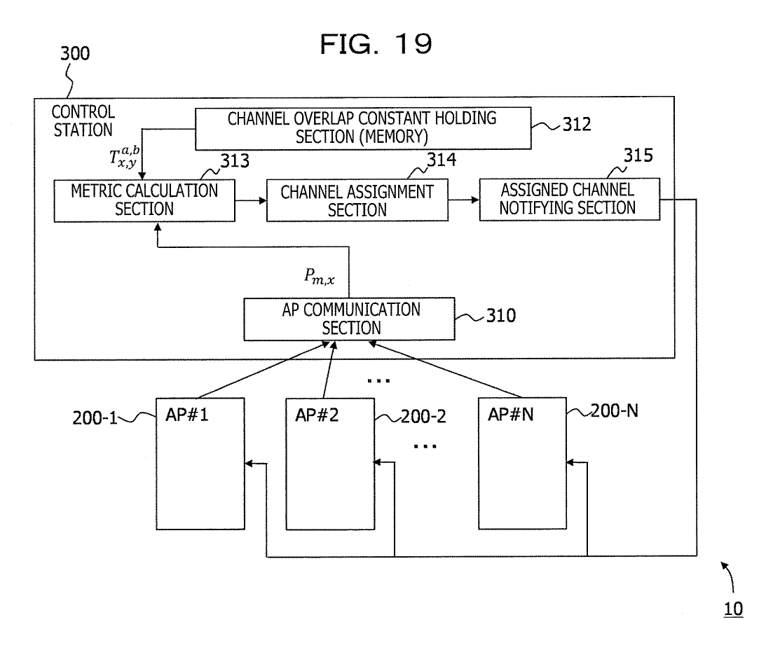

FIG. 18 illustrates an example of the configuration of the AP 200-1. FIG. 19 illustrates an example of the configuration of the control station 300. The AP 200-1 further includes a demanded use rate calculation section 220. Meanwhile, the control station 300 does not include a demanded use rate calculation section 311 compared to the second embodiment (e.g. FIG. 4). In this case, the demanded use rate calculation section 220 calculates the demanded use rate in the AP 200 as in the second embodiment, and transmits the demanded use rate to the control station 300. The metric calculation section 313 of the control station 300 may calculate the metric I^{C} based on the demanded use rate which is transmitted from the AP 200 as in the second embodiment (e.g. FIGS. 9A to 14B).

### Other Embodiments

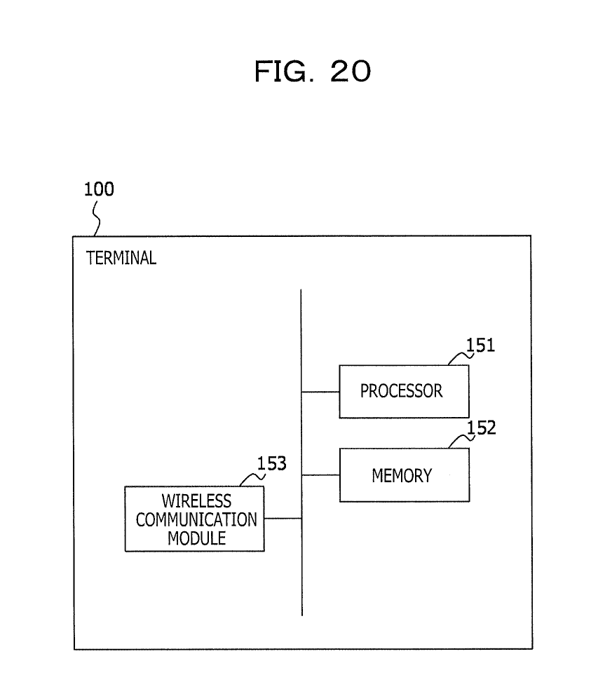

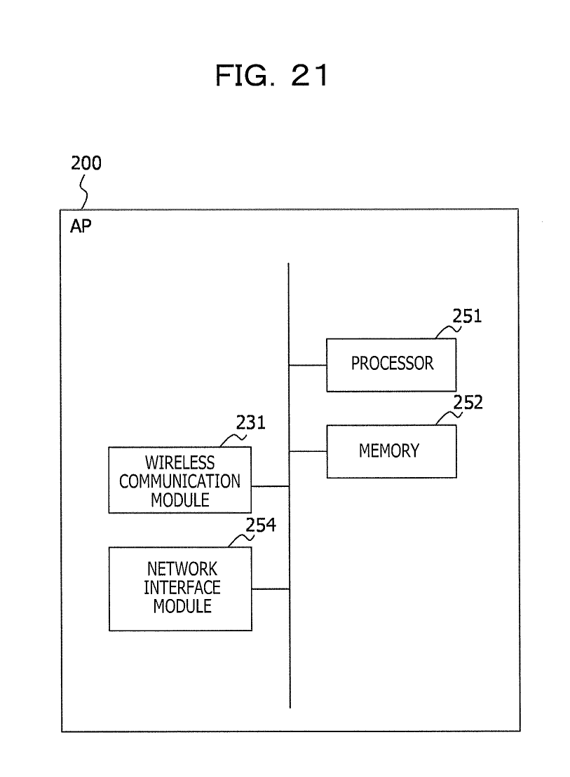

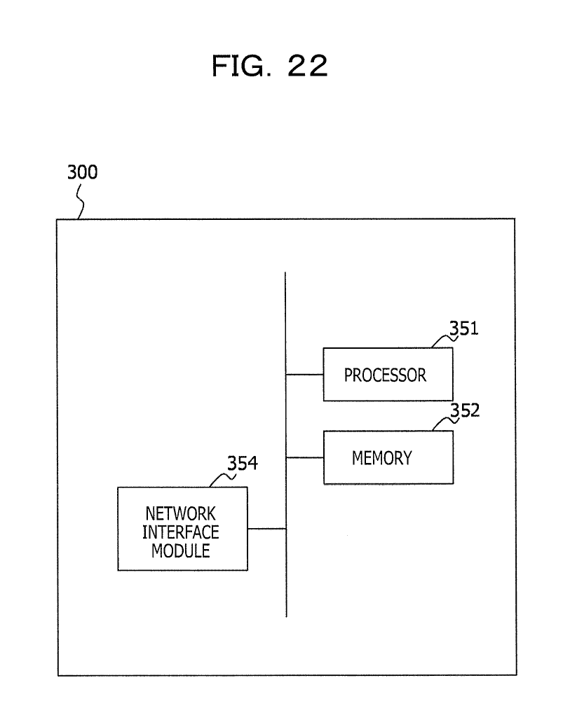

Next, other embodiments will be described. FIG. 20 illustrates an example of the hardware configuration of the terminal 100. FIG. 21 illustrates an example of the hardware configuration of the AP 200. FIG. 22 illustrates an example of the configuration of the control station 300. The embodiments discussed above may also be implemented with such hardware configurations.

The terminal 100 includes a processor 151, a memory 152, and a wireless communication module 153. A processor or processor circuity may include a device that has any combination of hardware, circuity, and software. The hardware and circuitry examples may comprise a parallel processor, a processor array, a vector processor, a scalar processor, a multi-processor, a microprocessor, a communication processor, a network processor, a logic circuit, a queue management device, a central processing unit (CPU), a micro processing unit (MPU), system on a chip (SoC), a digital signal processor (DSP), an integrated circuit (IC), an application specific integrated circuit (ASIC), a programmable logic device (PLD), and a field programmable gate array (FPGA).

The processor 151 reads and executes a program stored in the memory 152 to execute the function of the terminal performance informing section 110, for example. The processor 151 corresponds to the terminal performance informing section 110 in the second embodiment, for example.

The wireless communication module 153 performs a process related to wireless communication in accordance with an instruction from the processor 151 to exchange a wireless signal with the AP 200, for example. The wireless communication module 153 corresponds to the AP communication section 120 in the second embodiment, for example.

The AP 200 includes a processor 251, a memory 252, a wireless communication module 231, and a network interface module 254.

The processor 251 reads and executes a program stored in the memory 252 to execute the function of the terminal performance informing section 211, the number-of-connected-terminals measurement section 212, the terminal traffic calculation section 213, the inter-AP received power measurement section 215, and the channel switching section 217, for example. The processor 251 corresponds to the terminal performance informing section 211, the number-of-connected-terminals measurement section 212, the terminal traffic calculation section 213, the inter-AP received power measurement section 215, and the channel switching section 217 in the second embodiment, for example.

The wireless communication module 231 performs a process related to wireless communication in accordance with an instruction from the processor 251 to exchange a wireless signal with the terminal 100, for example. The wireless communication module 231 corresponds to the terminal communication section 210 and the inter-AP received power measurement section 215 in the second embodiment, for example.

The network interface module 254 exchanges data or the like with the control station 300, for example. The network interface module 254 corresponds to the controller communication section 216 in the second embodiment, for example.

The control station 300 includes a processor 351, a memory 352, and a network interface module 354.

The processor 351 reads and executes a program stored in the memory 352 to execute the function of the demanded use rate calculation section 311, the metric calculation section 313, the channel assignment section 314, and the assigned channel notifying section 315, for example. The processor 351 corresponds to the demanded use rate calculation section 311, the metric calculation section 313, the channel assignment section 314, and the assigned channel notifying section 315, for example. The memory 352 holds the table 3120 illustrated in FIG. 1, and corresponds to the channel overlap constant holding section 312 in the second embodiment, for example. The network interface module 354 corresponds to the AP communication section 310 in the second embodiment, for example.

The processors 151, 251, and 351 of the terminal 100, the AP 200, and the control station 300, respectively, may be a controller such as a Central Processing Unit (CPU), a Micro Processing Unit (MPU), a Digital Signal Processor (DSP), and a Field Programmable Gate Array (FPGA), for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication controller comprising:
a memory; and
processor circuitly coupled to the memory and configured to:
calculate an expected value of an interference amount in a first wireless communication apparatus and a second wireless communication apparatus on the basis of a first use probability in a first frequency bandwidth, a second use probability in a second frequency bandwidth, the first and second frequency bandwidth being calculated on the basis of the traffic of a terminal apparatus, and received power of a signal received by the first wireless communication apparatus from the second wireless communication apparatus;
assign a first or second channel to the first and second wireless communication apparatuses on the basis of the expected value; and
notify the first or second channel which has been assigned to the first and second wireless communication apparatuses.

2. The communication controller according to claim 1,
wherein the expected value is calculated further on the basis of a weight value that matches positions of the first or second frequency bandwidth which is utilized by the first wireless communication apparatus for wireless communication with the terminal apparatus and the first or second frequency bandwidth which is utilized by the second wireless communication apparatus for wireless communication with the terminal apparatus and a position of the first or second channel which has been assigned to the first and second wireless communication apparatuses.

3. The communication controller according to claim 1,
wherein the first and second use probabilities are calculated.

4. The communication controller according to claim 3,
wherein the first and second use probabilities are calculated on the basis of the first or second frequency bandwidth which may support wireless communication of the terminal apparatus with the first and second wireless communication apparatuses.

5. The communication controller according to claim 3,
wherein the first and second use probabilities are calculated on the basis of the traffic amount which is calculated for the first or second wireless communication apparatus.

6. The communication controller according to claim 4,
wherein the first and second use probabilities are calculated such that the traffic amount is a value obtained by adding a value obtained by multiplying a first transmission rate for a case where the first frequency bandwidth is used in the terminal apparatus by the first use probability and a value obtained by multiplying a second transmission rate for a case where the second frequency bandwidth is used in the terminal apparatus by the second use probability.

7. The communication controller according to claim 4,
wherein the first and second use probabilities are calculated on the basis of the first or second frequency bandwidth that may support wireless communication transmitted from the terminal apparatus.

8. The communication controller according to claim 6,
wherein the first and second use probabilities are calculated on the basis of the first and second transmission rates transmitted from the terminal apparatus.

9. The communication controller according to claim 2,
wherein the memory stores the weight value, and
the expected value is calculated on the basis of the weight value stored in the memory and corresponding to the first and second frequency bandwidths and the first or second channel.

10. The communication controller according to claim 2,
wherein the expected value is calculated by multiplying the received power by the first and second use probabilities and the weight value.

11. The communication controller according to claim 2,
wherein, when the first and second frequency bandwidths are defined as x and y, respectively, the first and second channels are defined as a and b, respectively, the received power is defined as R_{1,2}, and the first and second use probabilities are defined as P_{1,x} and P_{2,y}, respectively, the expected value is calculated on the basis of a result of reading from the memory, and performing a calculation using,
$${I}_{1 , 2}^{a , b} = {\sum }_{y = 20 , 40 , 80} {\sum }_{x = 20 , 40 , 80} {R}_{1 , 2} {T}_{x , y}^{a , b} {P}_{1 , x} {P}_{2 , y}$$
wherein x=20, 40, 80 represents 20 MHz, 40 MHz, 80 MHz, respectively, y=20, 40, 80 represents 20 MHz, 40 MHz, 80 MHz,
I_{1,2}^{a,b}
represents the expected value of the interference amount which is received by the first wireless communication apparatus from the second wireless communication apparatus in a case where the first wireless communication apparatus performs wireless communication with the terminal apparatus using the first channel and the second wireless communication apparatus performs wireless communication with the terminal apparatus using the second channel, and
T_{x,y}^{a,b}
represents the weight value for a case where the first wireless communication apparatus receives a signal transmitted from the terminal apparatus in the first frequency bandwidth using the first channel and the second wireless communication apparatus transmits a signal to the terminal apparatus in the second frequency bandwidth using the second channel.

12. The communication controller according to claim 2,
wherein, when a number of wireless communication apparatuses is defined as N with the first wireless communication apparatus being an m-th (m is an integer that meets 1≦m≦N) wireless communication apparatus and with the second wireless communication apparatus being an n-th (n is an integer that meets 1≦n≦N) wireless communication apparatus, the first or second channel for the first wireless communication apparatus, which is the m-th, is defined as cₘ, and the first or second channel for the second wireless communication apparatus, which is the n-th, is defined as cₙ, the expected value is calculated by reading from the memory, and calculating,
$${I}^{C} = {\sum }_{m = 1}^{N} {\sum }_{n = 1}^{N} {I}_{m , n}^{{C}_{m} , {C}_{n}}$$
wherein
I^{C}
represents an expected value of an interference amount for an entirety of the N wireless communication apparatuses, and
I_{m,n}^{C}^{ₘ}^{,C}^{ₙ}
represents an expected value of an interference amount received by the first wireless communication apparatus, which is the m-th, from the second wireless communication apparatus, which is the n-th.

13. The communication controller according to claim 1,
wherein the terminal apparatus performs wireless communication with the first and second wireless communication apparatuses in the first or second frequency bandwidth including the first or second channel, a notification of which has been provided as the assigned channel.

14. The communication controller according to claim 1,
wherein the first or second channel is a primary channel prescribed under Institute of Electrical and Electronic Engineers (IEEE) 802.11ac.

15. A wireless communication system comprising:
a terminal apparatus;
a first and a second wireless communication apparatuses configured to perform wireless communication with the terminal apparatus; and
a communication controller including:
a memory; and
processor circuitry coupled to the memory and configured to:
calculate an expected value of an interference amount in the first and the second wireless communication apparatuses on the basis of a first use probability in a first frequency bandwidth, a second use probability in a second frequency bandwidth, the first and second frequency bandwidth being calculated on the basis of the traffic of the terminal apparatus, and received power of a signal received by the first wireless communication apparatus from the second wireless communication apparatus;
assign a first or second channel to the first and second wireless communication apparatuses on the basis of the expected value; and
notify the first or second channel which has been assigned to the first and second wireless communication apparatuses.

16. A communication method comprising:
calculating, by processor circuitry, an expected value of an interference amount in a first wireless communication apparatus and a second wireless communication apparatus on the basis of a first use probability in a first frequency bandwidth, a second use probability in a second frequency bandwidth, the first and second frequency bandwidth being calculated on the basis of the traffic of a terminal apparatus, and received power of a signal received by the first wireless communication apparatus from the second wireless communication apparatus;
assigning, by processor circuitry, a first or second channel to the first and second wireless communication apparatuses on the basis of the expected value; and
notifying, by processor circuitry, the first or second channel which has been assigned to the first and second wireless communication apparatuses.
